(19) United States
(12) Patent Application Publication
(10) Pub. No.: US 2009/0210142 A1
(43) Pub. Date: Aug. 20, 2009

(54) SAFE ROUTE CONFIGURATION

(75) Inventors: Jeffrey D. Couckuyt, Bothell, WA (US); Ivan J. Tashev, Kirkland, WA (US); Neil W. Black, Seattle, WA (US); John C. Krumm, Redmond, WA (US); Ruston Panabaker, Redmond, WA (US); Michael Lewis Seltzer, Seattle, WA (US)

Correspondence Address: TUROCY & WATSON, LLP, 127 Public Square, 57th Floor, Key Tower, CLEVELAND, OH, 44114, US

(73) Assignee: Microsoft Corporation, Redmond, WA (US)

(21) Appl. No.: 12/033,627

(22) Filed: Feb. 19, 2008

(51) Int. Cl. G01C 21/00

(52) U.S. Cl. 701/200

(57) ABSTRACT

Routes can be produced based on safety characteristics of paths that are included in the route. Safety characteristics can include how susceptible an area surrounding a path is to crime as well as traffic data, such as how many automobile accidents take place on average. Various amounts of safety information can be gathered and a particular path can be assigned a safety score. Analysis can run on different path combinations that would take a user from a starting point to an intended destination. A route can be produced based on the safety score alone, such as a route with a lowest score, based on the safety score with other factors such as anticipated traffic, and the like.

### TECHNICAL FIELD

The subject specification relates generally to route production and in particular to producing a route according to safety constraints.

### BACKGROUND

Computer-driven route planning applications are utilized to aid users in locating points of interest, such as particular buildings, addresses, and the like. Additionally, in several existent commercial applications, users can vary a zoom level, thereby enabling variation of context and detail as a zoom level of a map is altered. For example, as a user zooms in on a particular location, details such as names of local roads, identification and location of police and fire stations, identification and location of public services, such as libraries, museums, and the like can be provided to the user. When zooming out, the user can glean information from the map such as location of the point of interest within a municipality, state/providence, and/or country, proximity of the point of interest to major freeways, proximity of the point of interest to a specific city, and the like.

Furthermore, conventional computer-implemented mapping applications often include route-planning applications that can be utilized to provide users with directions between different locations. Pursuant to an example, a user can provide a route planning application with a beginning point of travel and an end point of travel (e.g., beginning and ending addresses). The route planning application can include or utilize representations of roads and intersections and one or more algorithms to output a suggested route of travel. These algorithms can output routes depending upon user-selected parameters. For instance, a commercial route planning application can include a check box that enables a user to specify that she desires to avoid highways. Similarly, a user can inform the route planning application that she wishes to travel on a shortest route or a route that takes a least amount of time (as determined by underlying algorithms). Over the last several years, individuals have grown to rely increasingly on route planning applications to aid them in everything from locating a friend's house to planning cross-country road trips.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

In a conventional route production system, a route is outputted according to constraints commonly selected by a user or inferred by user behavior. For instance, a user can ask for a route to an intended destination that is anticipated to take a least amount of time. Analysis of route histories and traffic patterns can occur and based upon a result of the analysis, a route can be outputted to a driver of a vehicle.

The disclosed innovation allows for safety of a route to be taken into account for route production, which includes travel safety (e.g., accident likelihood), neighborhood safety (e.g., crime rates along paths), etc. An evaluation component can analyze a path concerning safety and a fabrication component can produce a route that includes an analyzed path. The produced route is outputted as a function of safety data such that the route is designed to mitigate a user's exposure to danger. The fabrication component can create a new route as well as augment an existing route.

The disclosed innovation goes against market trends and conventional wisdom in route generation circles. Oftentimes, routes are generated with automobiles in mind, where users are relatively protected. However, little attention is paid to pedestrian travel, thus neighborhood safety can become very important, but it is oftentimes ignored. In addition, even if in a vehicle, a user can make an unexpected stop to fuel, correct a malfunction, and the like which can expose a user to a danger in a neighborhood in an unexpected manner (e.g., a neighborhood with confusing street signs that can cause a user to become confused and more prone to a dangerous situation).

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative safe route production system in accordance with an aspect of the subject specification.

FIG. 2 illustrates a representative safe route production system with a detailed evaluation component in accordance with an aspect of the subject specification.

FIG. 3 illustrates a representative safe route production system with a detailed fabrication component in accordance with an aspect of the subject specification.

FIG. 4 illustrates a representative safe route production system with an interaction component and disclosure component in accordance with an aspect of the subject specification.

FIG. 5 illustrates a representative system for safe route selection in accordance with an aspect of the subject specification.

FIG. 6 illustrates a representative methodology for augmenting a route concerning safety in accordance with an aspect of the subject specification.

FIG. 7 illustrates a representative route alteration methodology in accordance with an aspect of the subject specification.

FIG. 8 illustrates a representative safe route comparison methodology in accordance with an aspect of the subject specification.

FIG. 9 illustrates an example of a schematic block diagram of a computing environment in accordance with an aspect subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

As used herein, the terms to “infer” or “inference” refer generally to the process of reasoning about or deducing states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. It is to be appreciated that determinations or inferences referenced throughout the subject specification can be practiced through use of artificial intelligence techniques.

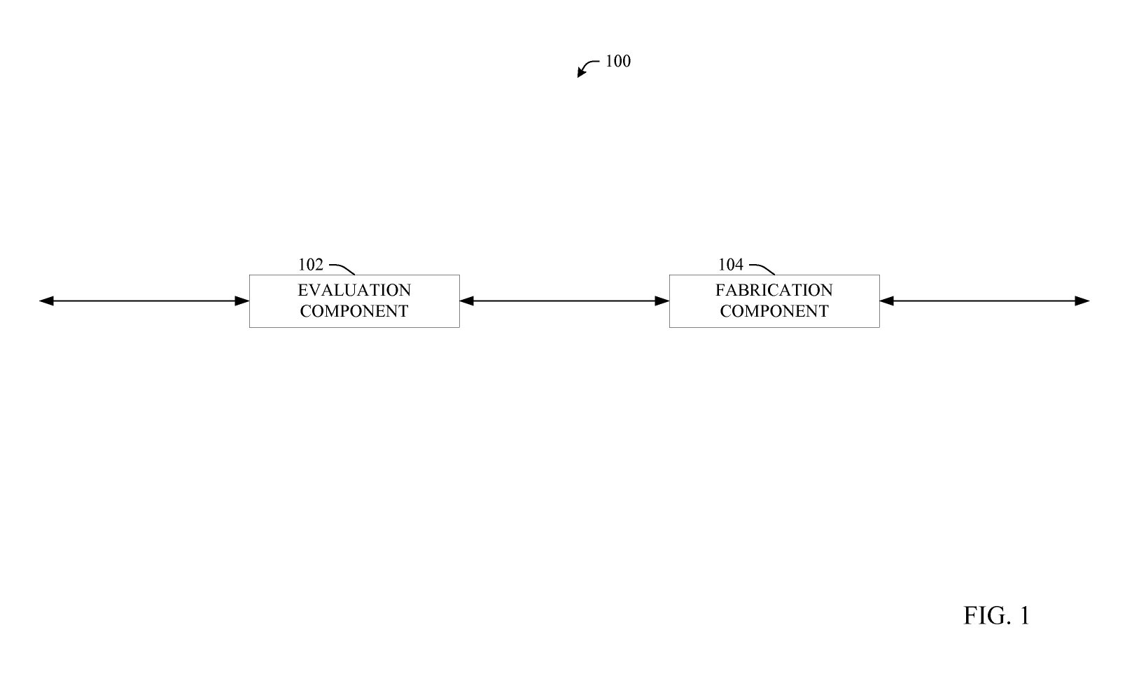

Now referring to FIG. 1, an example system 100 is disclosed for outputting a route that takes safety into consideration. Safety of paths traveled as well as neighborhoods surrounding those paths can have a large impact on a user's travel. If a path has a relatively high likelihood of being dangerous, then it can be advantageous for a user to have a different path selected. The disclosed innovation can analyze safety of a route/path and determines if the route/path should be presented to a user, such that a user can be relatively assure that the route/path is safe.

An evaluation component 102 can analyze at least one path based upon at least one safety characteristic of the path. A user can desire to travel from her home to a municipality several hundred miles away that she has not previously visited. Since the user is unfamiliar with the journey, she is likely unable to distinguish between safe routes and unsafe routes. Individual paths can be given a safety rating that is used in determining a danger level of a path. For instance, a path can be given a risk rating of ‘high’ (e.g., dangerous) from the evaluation component 102 and the evaluation component 102 can infer if a ‘high’ rating is acceptable to a user. The safety characteristics can be based upon historical safety data, an observation of contextual factors encompassing a path (e.g., a number of vehicles along the path), a safety prediction, or a combination thereof. In addition, the safety characteristic of the path can be based upon criminal statistics related to the path (e.g., overall statistics, violent crime against petty crime, etc.).

A fabrication component 104 can produce a route made of at least one analyzed path as a function of the analysis, the produced route mitigates potential risk to a user that is anticipated to take the route. Thus, an outputted route can be considered safe and thus alleviate concern to the user. Various paths can have different safety ratings and the fabrication component 104 can attempt to combine different paths to create a route that includes an overall safety rating made of at least one path. The fabrication component 104 can determine a route that is safest, meets safety needs of a user, etc. and establish that route as one the user should take. In addition, metadata about the route can be provided to the user, such as how safe a route is, statistics of individuals in similar situations (e.g., people who recently traveled along the route at the same time of day, in the same make/model of vehicle, who travel at speeds similar to the user, and the like). While the above describes producing a route considering safety, it is to be appreciated that aspects of the subject specification can be practiced considering safety in addition to other factors (e.g., traffic, route repairs and/or constructions, speed, distance, road roughness, route complexity, difficult turns, highways, scenic routes, and the like). It is possible that a safe route according to a user standard cannot be found (e.g., cannot be reasonably found). The fabrication component 104 can attempt to produce a route that has a safety standard acceptable to the user (e.g., the standard is provided by the user) and if a route that has the safety standard acceptable to the user cannot be made (e.g., cannot be reasonably be made, such as a route that is no more than about two times longer than a standard route), then a notification can transfer to the user that a general route is produced because a route according to the standard could not be produced. However, it is also possible for the fabrication component 104 to produce a best route—a route that does not meet the standard, but is still considered a safest option.

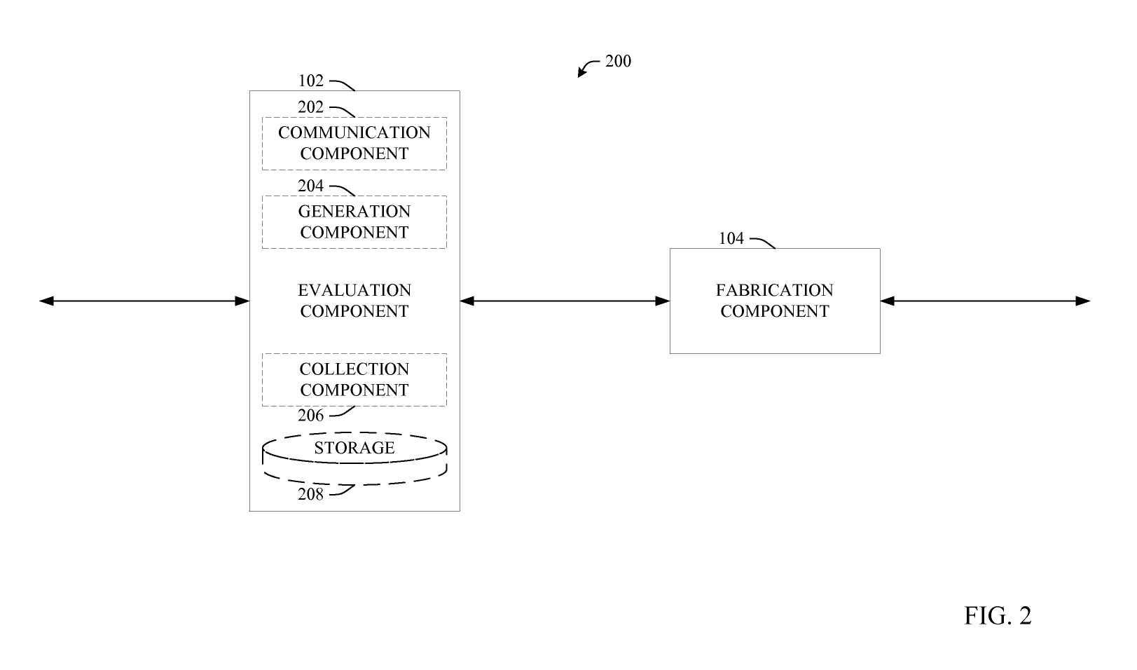

Now referring to FIG. 2, an example system 200 is disclosed for outputting a route that takes safety into consideration with a representative expanded evaluation component 102. The evaluation component 102 can analyze at least one path based upon a safety characteristic of the path. A communication component 202 can engage with other devices to transfer information, such as to send a request for information, receiving information from an auxiliary source, etc. Operation can take place wirelessly, in a hard-wired manner, employment of security technology (e.g., encryption), etc. Information transfer can be active (e.g., query/response) or passive (e.g., monitoring of public communication signals). Moreover, the communication component 202 can utilize various protective features, such as performing a virus scan on collected data and blocking information that is positive for a virus.

A generation component 204 can construct at least one route between a start location and an intended destination. A user can input an intended destination to the system 200 and a starting position can be determined through utilization of a global positioning system. A mapping database can be accessed and the generation component 204 can create different routes between the starting point and intended destination based upon information in the mapping database, where the routes are made of at least one path. The generation component 204 can operate within certain constraints, such as creating a route that is reasonable (e.g., a route that requires a shortest time to traverse, a route that does not take a user on a path that is unpaved, and the like).

A collection component 206 can obtains various safety characteristics of the paths and/or routes constructed by the generation component 204, where the safety characteristics are used by the evaluation component 102 to analyze the route. Example safety characteristics can be based upon historical safety data, an observation of a user state (e.g., an increase in user heart rate can indicate nervousness and a reluctance to take routes regarded as less safe), a safety prediction, or a combination thereof. In addition, a safety characteristic of a path used in analysis can based upon criminal statistics related to the path.

Different pieces of information, such as collected materials, component operating instructions (e.g., of the collection component 206), source location, a component disclosed in the subject specification, etc. can be held on storage 208. Storage 208 can arrange in a number of different configurations, including as random access memory, battery-backed memory, hard disk, magnetic tape, etc. Various features can be implemented upon storage 208, such as compression and automatic back up (e.g., use of a Redundant Array of Independent Drives configuration). A fabrication component 104 can produce a route made of at least one analyzed path as a function of the analysis, the produced route mitigates potential risk to a user anticipated to take the route. According to one embodiment, if a route constructed by the generation component 204 is at an adequate safety level, then it can be produced to a user unchanged.

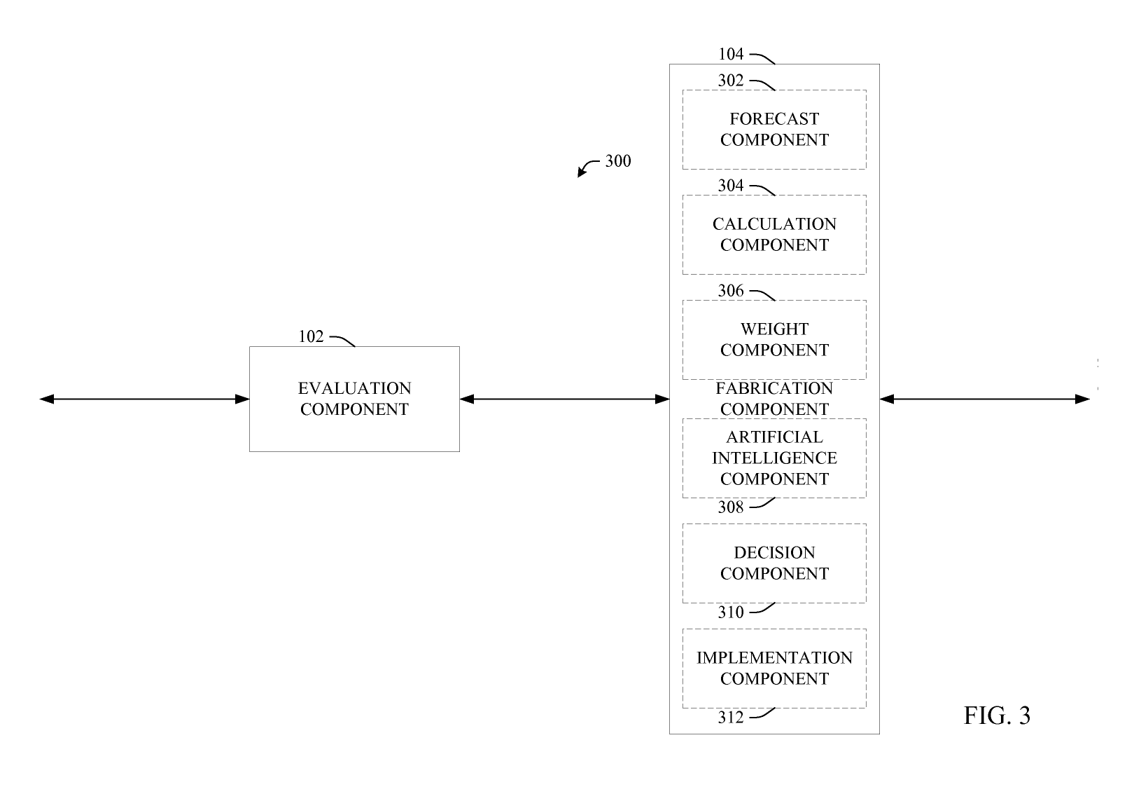

Now referring to FIG. 3, an example system 300 is disclosed for outputting a route that takes safety into consideration with a representative expanded fabrication component 104. An evaluation component 102 can analyze at least one path based upon at least one safety characteristic of the path. A result of the analysis can be accessed by the fabrication component 104 that can produce a route made of at least one analyzed path as a function of the analysis, the produced route mitigates potential risk to a user anticipated to take the route.

A forecast component 302 can predict a safety characteristic for a path, commonly based upon data obtained from the collection component 206 of FIG. 2. Oftentimes, situations arise that are not indicative of past behavior, but that arise out of a set of circumstances. For example, a street can have a number of late-night establishments—while during most times there are few unsafe conditions, typically between about 2 AM and about 3 AM there can be a relatively large number of people can enter the street (e.g., from the establishments closing) causing an unsafe condition. The forecast component 302 can predict based on past behavior that between about 2 AM and about 3 AM on a future date the street is less safe. While predictions can be based on history, predictions can also be based on other data, such as expectations of individuals (e.g., people think a new curfew not yet implemented will make things safer, and this belief can be used in route production.). In another example, when a major sport event starts or ends, there can be relatively large crowds on the streets and traffic congestion that increase safety risk.

A calculation component 304 can compile a safety rating of the path, the safety rating is used in path analysis or route production. The safety rating can be a score based upon history, observation, predictions, and the like. In addition to path information, other data can be used to compile the safety rating (e.g., if a user has a poor history driving at night, then if a street is known to have poor lighting, then more influence can be given).

A weight component 306 can apply a factor to the safety rating and balances the factored safety rating with at least one production constraint related to the route to produce a route metric. A user can desire to have a route produced based upon multiple constraints—safety, traffic, distance, time, and the like. The weight component 306 can determine how important the constraints are to a user (e.g., explicitly ask the user, infer from previous actions, and the like) and apply appropriate factors. According to one embodiment, routes are given weighted scores based on each constraint (e.g., an about 0.4 in safety, an about 0.6 in traffic, and so on). Weights can be applied based on various factors related to intensity—if a route has a number of small accidents, then the route can be given a better safer score then a different route with the same number of accidents, but a greater number of those accidents include fatalities. The weight component 306 can be set to user specifications, such as a user specifying that he is willing to take a with a specific safety rating (e.g., the user requests to take a route that has no more then X chance of serious injury). Weighted scores can be aggregated together by the weight component 306 to produce a route metric.

An artificial intelligence component 308 can make at least one inference or at least one determination toward path analysis or route production. For example, the artificial intelligence component 308 can infer that a new tourist attraction is likely to produce more crime and thus make a neighborhood surrounding a route unsafe. In an illustrative instance, the artificial intelligence component 308 can determine that a user desires to avoid particular routes regardless of safety rating and the like.

The artificial intelligence component 308 can employ one of numerous methodologies for learning from data and then drawing inferences and/or making determinations related to applying a service (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems.

A decision component 310 can select the route for production based upon the route metric. According to one embodiment, multiple potential routes are produced by the generation component 204 of FIG. 2 with associated scores created by the weight component and the decision component 310 selects a highest/lowest score for presentment to a user; however, other configurations can be implemented. For instance, a first route can be extremely safe, but take an extremely long time while a second route can be somewhat safe, but relatively quick. Though the metrics can be equal, since there is less deviation between constraint scores, the second route can be selected. In an alternative practice, the decision component 310 can determine if a route (e.g., produced by the generation component 204 of FIG. 2, gathered from a remote location, and the like) is at an acceptable safety level. If the route is at an acceptable safety level, then it can be produced to a user—however, if the route is not at an acceptable safety level, then the route can be altered by the fabrication component 104 and can be retested by the decision component 310.

An implementation component 312 can perform actions consistent with outputting a selected route. It is possible that a number of routes are created by the system 300, but one route is selected by the decision component 310. In an alternate embodiment, a user can be presented multiple routes meeting desired criteria and the user can select a route to follow, to be displayed, and the like. The implementation component 312 can forward the route to an auxiliary unit (e.g., a personal electronic device) and delete routes not used.

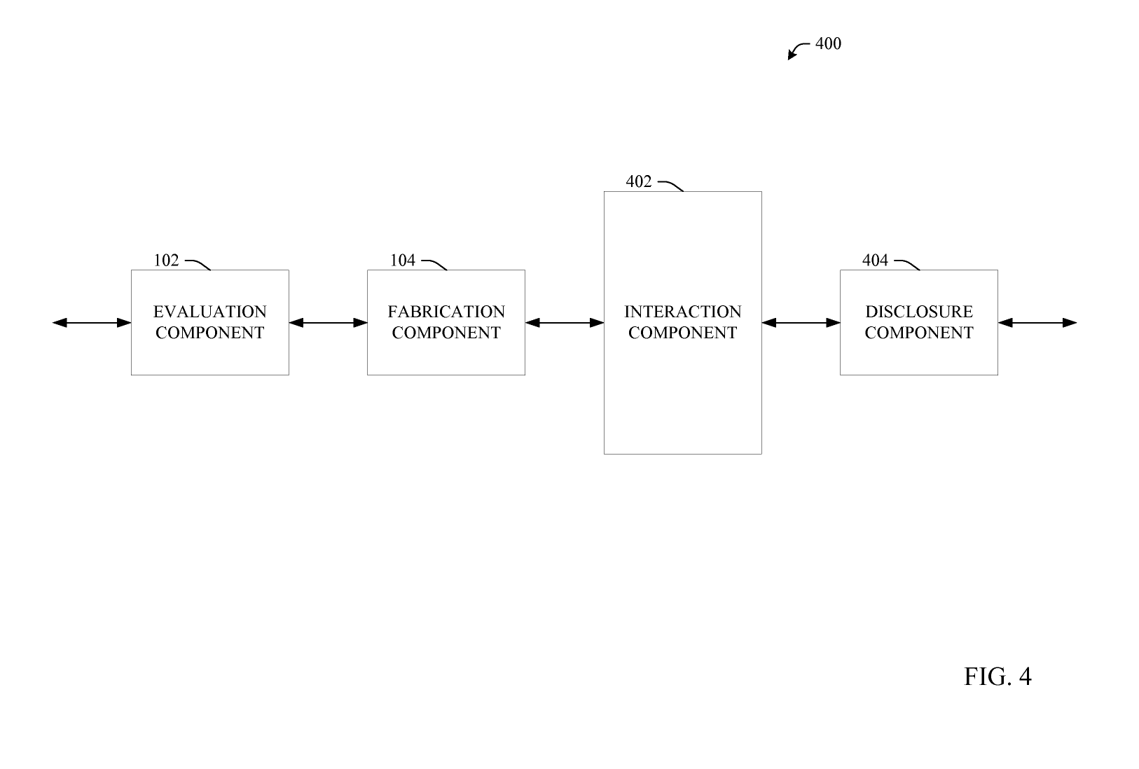

Now referring to FIG. 4, an example system 400 is disclosed for outputting a route that takes safety into consideration with a representative expanded interaction component 402 and disclosure component 404. An evaluation component 102 can analyze at least one path based upon at least one safety characteristic of the path. A fabrication component 104 can produce a route made of at least one analyzed path as a function of the analysis, the produced route mitigates potential risk to a user anticipated to take the route

An interaction component 402 can enable a user to input information to the system 400. Commonly, the interaction component 402 can implement as a touch screen of the disclosure component 404, a keyboard, microphone, and the like. While shown independently, the interaction component 402 can implement as part of the collection component 206 to collect other information types (e.g., an intended destination, a notice from a user of a neighborhood that she considers unsafe, etc.), as part of the disclosure component 404, and the like.

A disclosure component 404 can provide the route to a user (e.g., operating a vehicle passenger or operator, as a pedestrian, etc.). A non-exhaustive list of disclosure components include a display screen, touch screen, speaker system, virtual reality environment, Braille production system, printer, etc. In addition, the disclosure component 404 can present information in multiple formats, such as showing a video with audio capabilities. Moreover, the disclosure component 404, as well as other components disclosed in the subject specification can implement upon a personal electronic device (e.g., cellular telephone, personal digital assistant, etc.), upon a vehicle (e.g., automobile, motorcycle, bicycle, airplane, helicopter, motorboat, self-balancing transportation device, etc.), and so forth.

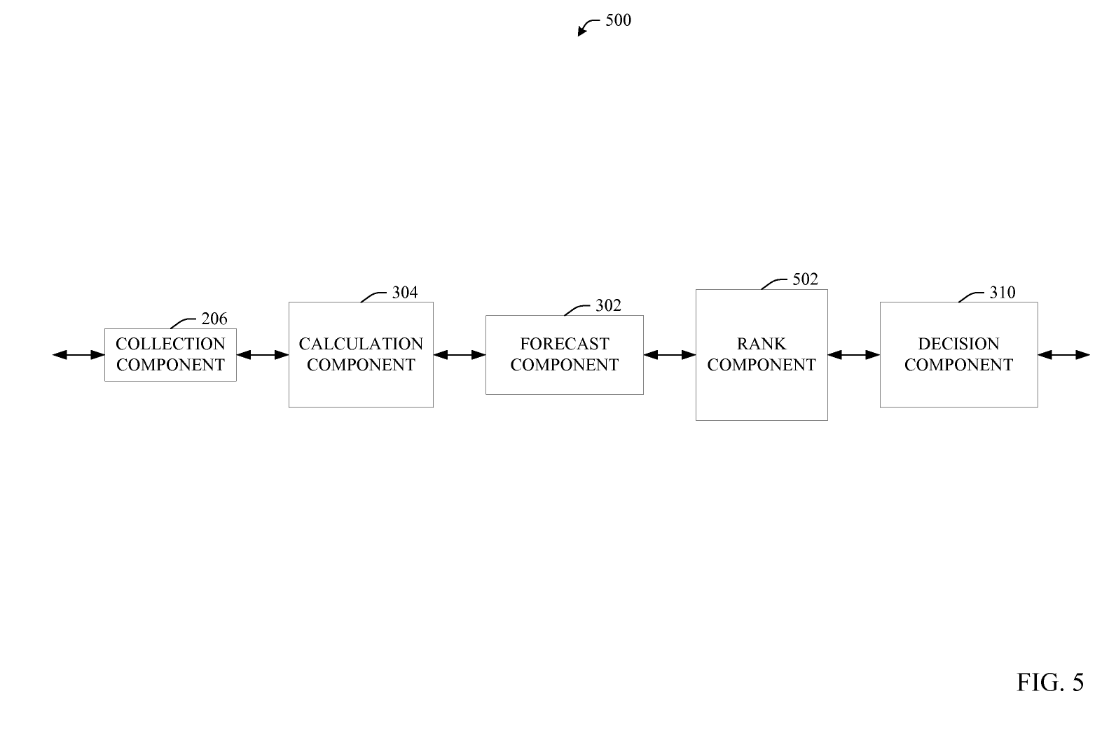

Now referring to FIG. 5, an example system 500 is disclosed for producing a route based upon at least one safety characteristic. A collection component 206 can gather various information that relates to safety of a route. The collection component 206 can function as a means for collecting historical safety data for a path as well as current safety data for the path, safety data of the path is based upon criminal statistics related to the path.

A calculation component 304 can determine a safety level based upon the gathered safety information. The calculation component 304 can operate as a means for calculating a safety level for the path based upon the collected data. It is to be appreciated that other components disclosed in the subject specification that are not shown can engage with the system 500. For instance, the evaluation component 102 of FIG. 1 and/or fabrication component 104 of FIG. 1 can engage the system 500 and provide appropriate functionality.

A forecast component 302 can predict how exposed a user would be to dangers associated with a path. For instance, if heavy storms are approaching, then a user in an automobile with relatively slick tires can be in more danger then a user with rain-designed tires. The forecast component 302 can implement as a means for predicting an exposure level for a user anticipated to travel along a path.

A rank component 502 can compare the path safety with the exposure level and based upon the comparison, create a path danger order for a user. The order can be based upon a learned history of the user, upon a scoring system, as well as other standards. The rank component 502 can operate as a means for ranking at least one path combination based upon the safety level and the predicted exposure level.

A decision component 310 can appreciate an order of paths and designate at least one path for presentment to a user. In addition, the decision component 310 can perform aggregation such that different paths are combined together to form a route. The decision component 310 can function as a means for selecting at least one path combination for presentation to the user based upon the ranking. Ultimately, the selected route can be presented to the user through the disclosure component 404 of FIG. 4.

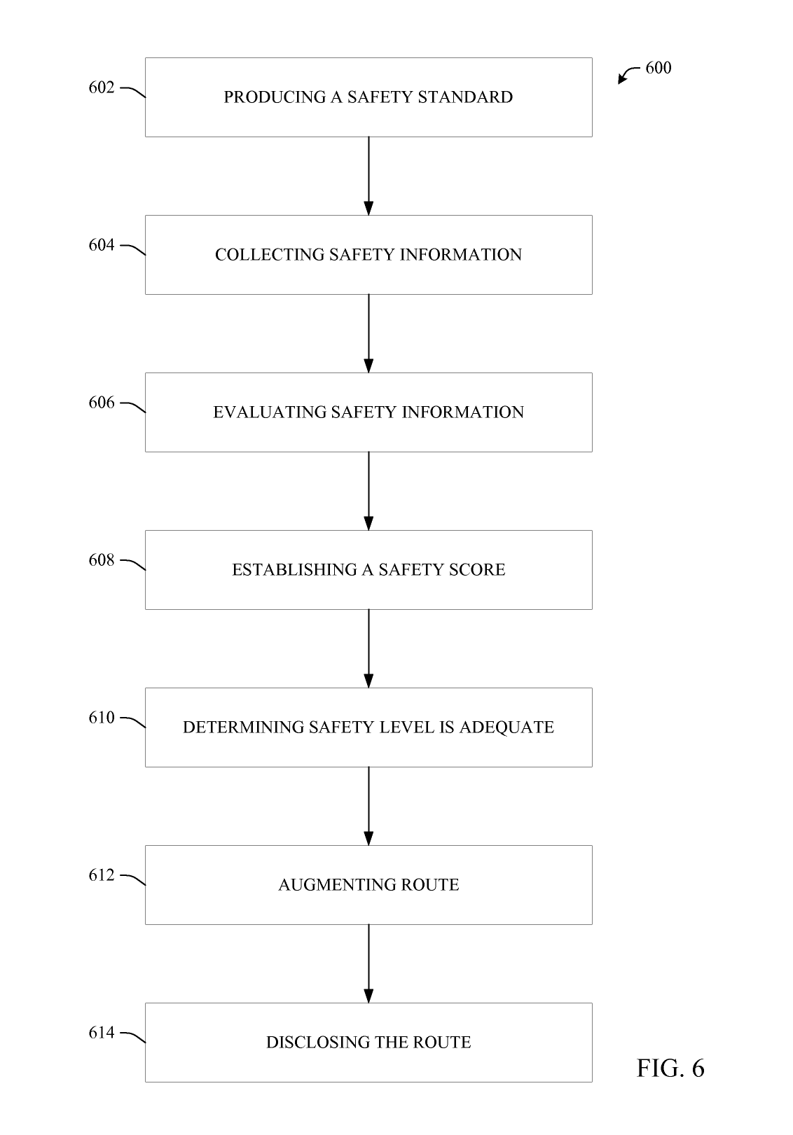

Now referring to FIG. 6, an example methodology 600 is disclosed for modifying a route to make the route safer. A safety standard can be produced at action 602, commonly based upon an acceptable level inferred from user characteristics. According to one embodiment, the methodology 600 can be practiced using routing score, where a standard is set at a number (e.g., do not use a route under a score of about ten unless no other route is available). However, the standard can be more general, such as a route considered ‘generally’ safe, where routes are compared against a looser standard. The safety standard can be produced automatically, automatically and then checked by a user, collected from a user, and the like

At block 604, different safety information can be collected from a variety of sources. A number of different entities can provide safety information, including news stations, other vehicles, municipal groups (e.g., police, fire response, hospital, and the like). The safety information can be collected and it is possible for an initial filtering to occur (e.g., to eliminate data that is inaccurate, such as if three news stations report an accident, then a fourth news station report stating a road is clear can be deleted).

At action 606, safety information (e.g., the collected safety information) can be evaluated. According to one embodiment, safety information can be listed as positive, negative, or neutral. For instance, if a police station is located along a route, then the route can be given a positive credit. However, a relatively high volume of crime data along a route can supply a negative credit.

A safety score can be established at act 608, oftentimes based upon a result of the safety information evaluation. This can include adding the credits together to gain a total score (e.g., adding the positives with the negatives) or accounting for worse safety anywhere on a road (e.g., the safety score of the road is maximum of the all segments). While credits can be one-for-one, it is possible to apply weight to the information in compiling a score. For instance, if data of a high accident rate is very old and taken before a new stop light was added, then a low weight can be given to the information.

A determination is made on if the safety score is adequate at action 610—thus determining that a safety score for a route is not at an acceptable standard. Commonly, this can include a comparison between the standard produced at action 602 against the safety score established at act 608. According to one embodiment, if the safety score is lower than or equal to the standard, then the route can be augmented. However, in a different configuration, if the safety score is equal to the standard, then the route can be disclosed to a user. If the safety score is not adequate, then the route can be augmented through act 612—the augmentation can be an attempt to improve the safety score and thus place the route in an allowable condition. Example augmentations can include reconstructing a route, changing a time a user will pass through an area, and the like.

The augmented route can be disclosed to a user, to a user's personal electronic device, and the like at action 614. The route can be communicated wirelessly to a disclosure device while utilizing various protective features (e.g., encryption, memory back up, and the like). User feedback on a route can also be collected and used to modify different aspects disclosed in the subject specification, such as altering how a safety standard is produced. For instance, if a specific user states that a route is not safe enough, then standard production can be changed such that higher standards are outputted for the specific user and/or globally.

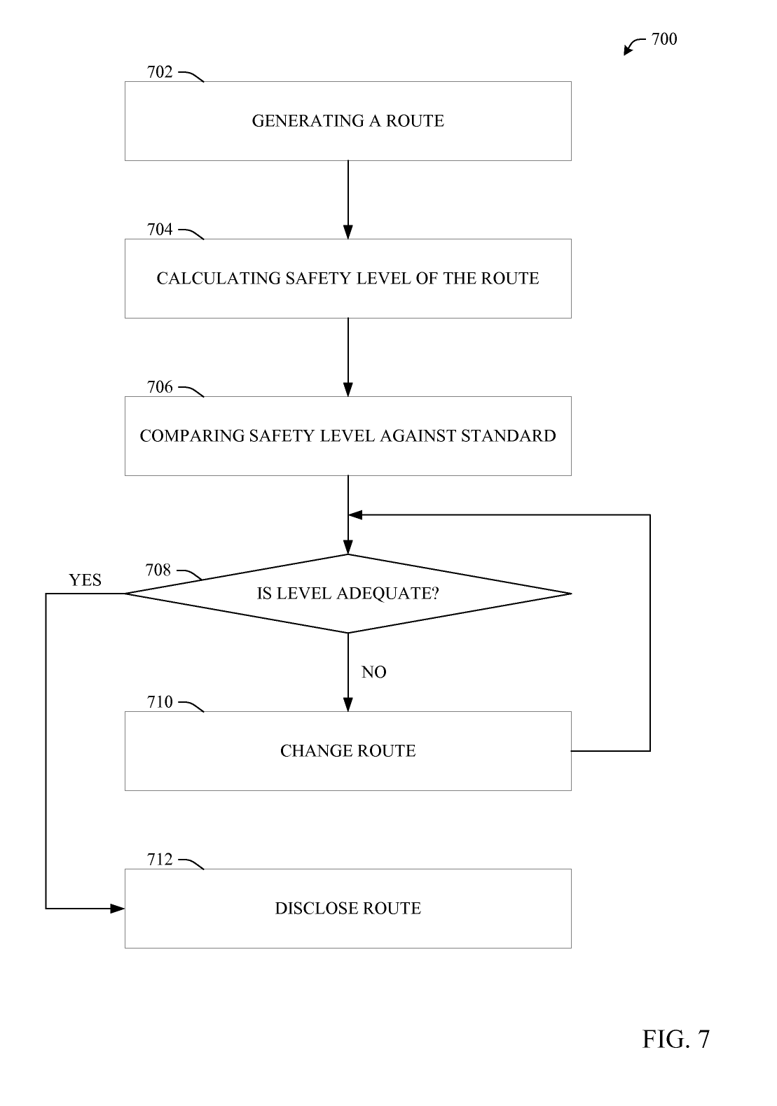

Now referring to FIG. 7, an example methodology 700 is disclosed for comparing a safety score against a standard. A route can be generated at action 702. A user can input an intended destination, an intended time of travel (e.g., specific time, range of time, event based time such as after a baseball game, etc.), a starting point, and the like. In addition, different information can be inferred, such as destination, time of travel, etc. Based on the information, as well as mapping data and safety details, a route can be created.

A safety score of the generated route can be calculated at event 704. Event 704 can include evaluating the route to determine statistical characteristics of the route and applying an algorithm to the statistical characteristics, where the result of the algorithm application can be the safety score. Various checks can be performed to verify the safety score, such as running the algorithm multiple times to verify consistent results. In addition to calculating a safety score for the route, safety scores can be calculated for paths included upon the route.

At block 706, the safety score of the generated route can be compared against a safety standard. In addition, safety scores of paths that are included the route can be calculated and compared against the safety standard. A check 708 can analyze a result of the comparison performed at block 706 and determine if the safety score is adequate. Check 708 can include determining that a safety score for a route is not at an acceptable standard.

If the safety score is not adequate, then the route (e.g., the route includes at least one path) can be modified through event 710. According to one embodiment, a path with a worst safety score (e.g., a level that is furthest from the standard) can be eliminated and a discovery can be made if an alternate path is available—the alternate route is patched into the route. Different checks can take place to determine feasibility of the patch, such as if a new path significantly increases travel time. If a change is considered unfeasible, then a different path can be replaced, a new replacement of the old path can occur, and the like.

The methodology 700 can represent augmenting a route in a manner to bring the safety score to an acceptable standard, which includes making a change to the route (e.g., event 710) and determining if the change is sufficient to bring the safety score to the acceptable standard (e.g., check 708). If the change is not sufficient, then there can be reiteration of making the change and determining if the change is sufficient. According to one embodiment, augmentation can attempt to optimize safety (e.g., complete optimization, reasonable optimization); however, augmentation can also merely attempt to bring the safety score above the standard. If the safety score is considered adequate, then the route can be disclosed to a user, to a personal electronic device, and the like through event 712. According to one embodiment, in order for a route to be disclosed, a user or device is required to provide a level of authentication.

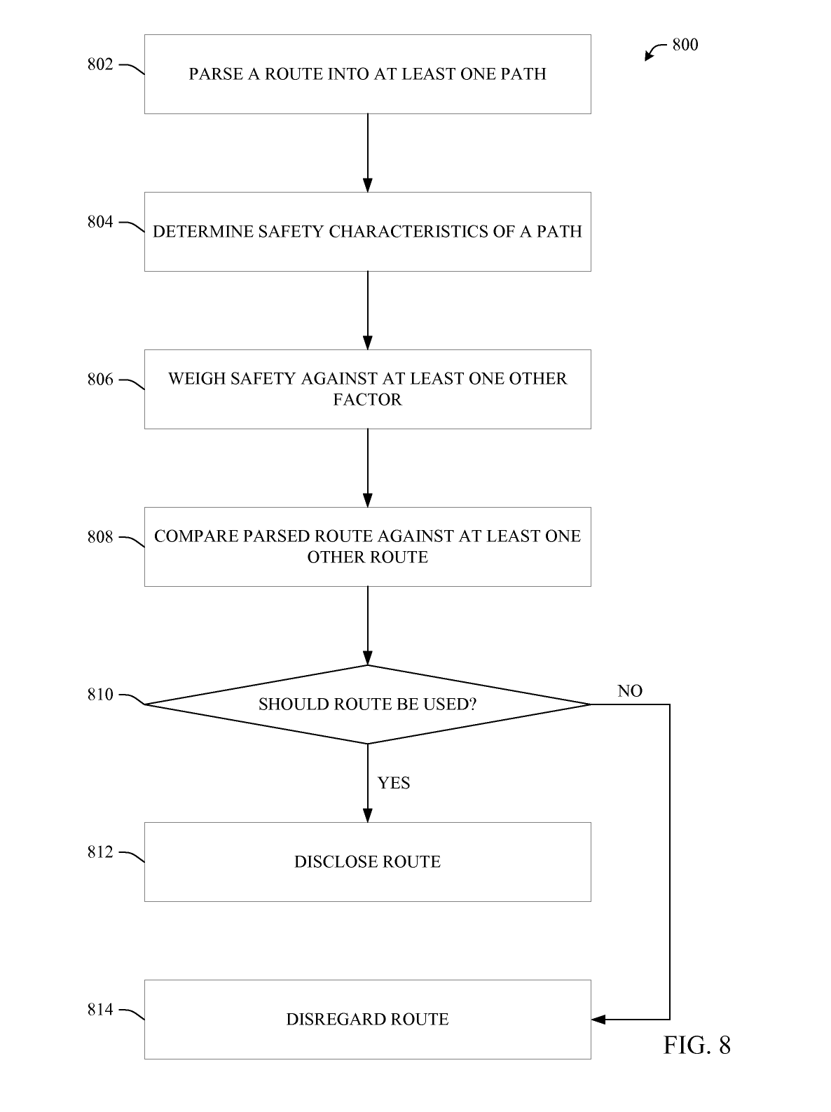

Now referring to FIG. 8, an example methodology 800 is disclosed for determining if a route should be used based against other routes. At block 802, a route can be parsed into different paths (e.g., roads, streets, trails, sidewalks, road sections, and the like). Division of the route can take place systematically (e.g., a break occurs about every 0.1 miles), constructively (e.g., street by street), based upon instruction of the user, and the like.

At event 804, a safety characteristic of the path can be determined. Information pertaining to a path can be collected and analyzed in order to determine a safety characteristic of a path. A path can be safe according to one standard (e.g., low on crime); however, according to a different standard, there can be numerous safety problems (e.g., high accident likelihood). The safety characteristic can be determined based upon a situation of a potential user (e.g., a person driving in an automobile is likely more protected and can change more quickly than a person walking.)

Safety of the route can weighed with at least one other factor at action 806. Based upon the safety characteristic, an overall safety factor can be determined (e.g., sum of path safety factors) and weighted with other factors. For instance, a route that is very safe can take a user on a much longer journey than other routes—therefore, the route is likely to have a relatively high safety score, but a relatively low time and/or distance score.

The parsed route can be compared with at least one other route at act 808. According to one embodiment, the comparison balances scores of routes against one another; however, other configurations can be practiced. For instance, individual weighted factors of different routes can be compared against one another as opposed to comparison of the overall score.

A check 810 can take place at 810 to determine if a route should be used. If the route should be used, then the route can be disclosed to the user at event 812, commonly through a visual unit and/or an audio unit. However, if the route is not to be used based upon the determination made at check 810, then the route can be disregarded at act 814. Disregarding the route can include deleting the route from memory, placing it in volatile storage so it can be retrieved during an operation session, but is ultimately deleted, and the like.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

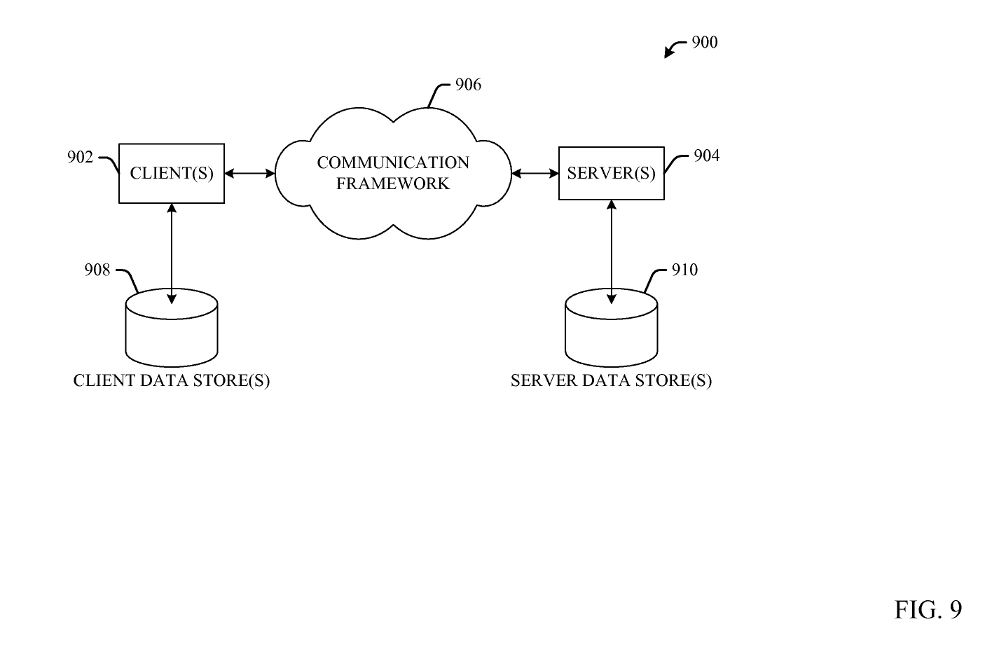

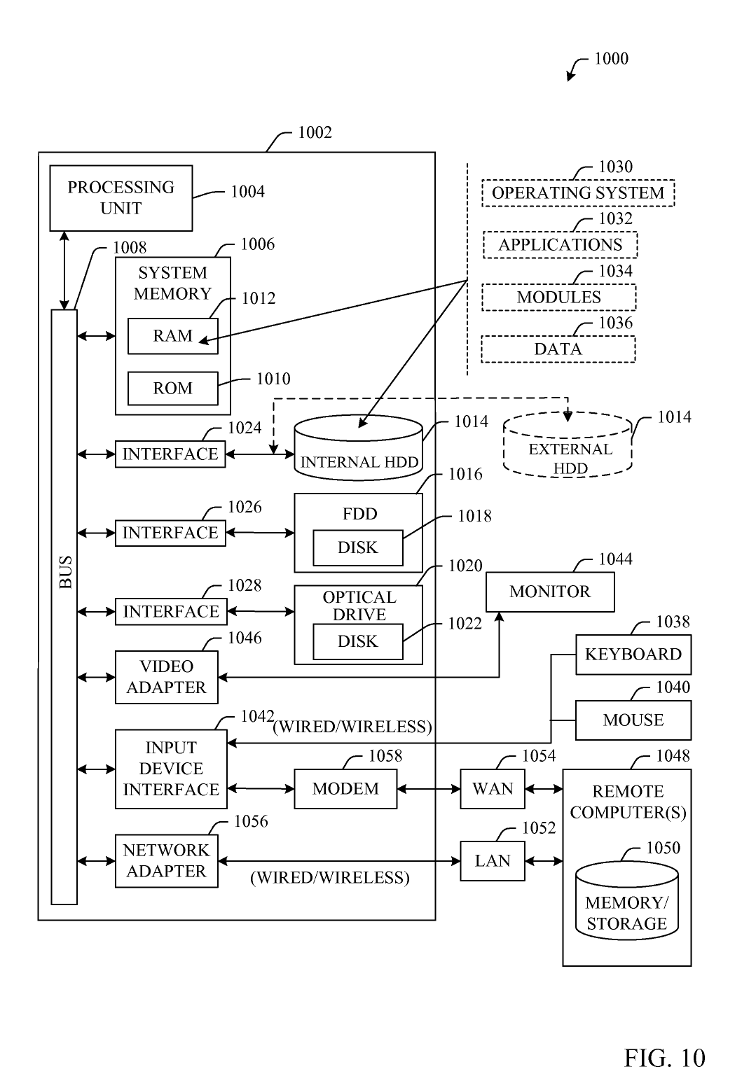

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embody computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors or proprietary specific configured processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various proprietary or commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the input device interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an evaluation component that analyzes at least one path based upon at least one safety characteristic of the path; and
a fabrication component that produces a route made of at least one analyzed path as a function of the analysis, the produced route mitigates potential risk to a user anticipated to take the route.

2. The system of claim 1, further comprising an artificial intelligence component that makes at least one inference or at least one determination toward path analysis or route production.

3. The system of claim 1, further comprising a calculation component that compiles a safety rating of the path, the safety rating is used in path analysis or route production.

4. The system of claim 3, further comprising an interaction component that collects safety data from a user, the safety data from the user is used to compile the safety rating.

5. The system of claim 3, further comprising a weight component that applies a factor to the safety rating and balances the factored safety rating with at least one production constraint related to the route to produce a route metric.

6. The system of claim 5, further comprising a decision component that selects the route for production based upon the route metric.

7. The system of claim 1, where the safety characteristic is based upon historical safety data, an observation, a safety prediction, or a combination thereof.

8. The system of claim 7, further comprising a forecast component that predicts a safety characteristic for the path.

9. The system of claim 1, the fabrication component attempts to produce a route that has a safety standard acceptable to the user and if a route that has the safety standard acceptable to the user cannot be made, then notifying the user that a standard route is produced.

10. The system of claim 1, the safety characteristic of the path is based upon criminal statistics related to the path.

11. A method, comprising:
determining that a safety score for a route is not at an acceptable standard; and
augmenting the route in a manner to bring the safety score to the acceptable standard.

12. The method of claim 11, further comprising evaluating safety information, a result of the evaluation is used in determining that the safety score for the route is not at the acceptable standard.

13. The method of claim 12, further comprising collecting safety information that pertains to the route, the collected safety information is evaluated.

14. The method of claim 11, further comprising establishing the safety score.

15. The method of claim 11, augmenting the route in a manner to bring the safety score to the acceptable standard includes making a change to the route and determining if the change is sufficient to bring the safety score to the acceptable standard.

16. The method of claim 15, if the change is not sufficient, then there is reiteration of making the change and determining if the change is sufficient.

17. The method of claim 11, further comprising disclosing the augmented route.

18. The method of claim 11, further comprising producing the acceptable standard.

19. The method of claim 11, further comprising generating the route upon which the safety score is determined.

20. A system, comprising:
means for collecting historical safety data for a path as well as current safety data for the path, safety data of the path is based upon criminal statistics related to the path;
means for calculating a safety score for the path based upon the collected data;
means for predicting an exposure level for a user anticipated to travel along a path;
means for ranking at least one path combination based upon the safety score and the predicted exposure level; and
means for selecting at least one path combination for presentation to the user based upon the ranking.
